(19) United States
(12) Patent Application Publication
(10) Pub. No.: US 2010/0125784 A1
(43) Pub. Date: May 20, 2010

(54) METHODS AND SYSTEMS FOR IMPLEMENTING FLAGGING FOR DIFFERENTIATING VISUAL INFORMATION IN A USER INTERFACE

(75) Inventors: Ty Hayden, Grand Junction, CO (US); Anadi Upadhyaya, Hyderabad (IN); Krishnaraj Mahadevan, Hyderabad (IN)

Correspondence Address: TOWNSEND AND TOWNSEND AND CREW LLP/ORACLE, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/274,847

(22) Filed: Nov. 20, 2008

(51) Int. Cl. G06F 17/00; G06F 17/30

(52) U.S. Cl. 715/275

(57) ABSTRACT

This disclosure describes, generally, methods and systems for differentiating visual information in a user interface (UI). The method may include defining criteria for multiple flag colors. The criteria may be based at least in part on a database query. The method may further include executing the database query on a plurality of data entries stored within a database in order to assign at least one of the multiple flags to each of the data entries. The color of the flag is based at least in part on data within each of the data entries meeting the criteria which defines the color of the flag. The method may further include displaying, within a UI on a display device, the data entries with the associated colored flags.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The present invention relates, in general, to displaying of information and, more particularly, to differentiating visual information within a display.

### BACKGROUND

Presently, when a query is run on data within a database, a manager or administrator sets the query, runs the query, and then views the data produced by the query. The administrator/manager is typically attempting to gather certain information about the data. For example, the data displayed may be showing the performance of various employees. From the performance data, the administrator or manager may be attempting to determine which employee should receive raises, bonuses, stock option grant, etc. However, by simply looking at the data, it can be difficult to make such determinations. Accordingly, a way in which to simply and quickly make such determinations when viewing such data is needed. Hence, there is a need for improved methods and systems in the art.

### BRIEF SUMMARY

Embodiments of the present invention are directed to a method of differentiating visual information in a user interface (UI). The method may include defining criteria for multiple flag colors. The criteria may be based at least in part on a database query. The method may further include executing the database query on a plurality of data entries stored within a database in order to assign at least one of the multiple flags to each of the data entries. The color of the flag is based at least in part on data within each of the data entries meeting the criteria which defines the color of the flag. The method may further include displaying, within a UI on a display device, the data entries with the associated colored flags.

According to further embodiments, a system for differentiating visual information in a UI is described. The system may include a database which is configured to store data in data entries and to provide access to the data. The system may further include a computing device, coupled with the database. The computing device may be configured to receive flag color criteria. The criteria may be associated with a database query. The computing device may further execute the database query on the data within the data entries in the database and assign graphical colored flags to each of the data entries based on the criteria. The system may further include a display, coupled with the computing device. The display may be configured to display each of the data entries with each of the data entry's assigned colored flag.

In an alternative embodiment, a machine-readable medium is described. The machine-readable medium may include instructions for differentiating visual information in a UI. The machine-readable medium may include instructions for defining criteria for multiple flag colors. The criteria may be based at least in part on a database query. The machine-readable medium may further include instructions for executing the database query on a plurality of data entries stored within a database in order to assign at least one of the multiple flags to each of the data entries. The color of the flag is based at least in part on data within each of the data entries meeting the criteria which defines the color of the flag. The machine-readable medium may further include instructions for displaying, within a UI on a display device, the data entries with the associated colored flags.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a generalized schematic diagram illustrating a computer system, in accordance with various embodiments of the invention.

FIG. 2 is a block diagram illustrating a networked system of computers, which can be used in accordance with various embodiments of the invention.

FIG. 3 is a flow diagram illustrating a method of differentiating visual information in a user interface (UI), according to one embodiment of the present invention.

FIG. 4 is a block diagram illustrating a system for differentiating visual information in a UI, according to embodiments of the present invention.

FIGS. 5A and 5B are graphical displays illustrating setting criteria options, according to embodiments of the present invention.

FIG. 6 is a graphical display illustrating differentiating visual information in a UI, according to embodiments of the present invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below and, while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

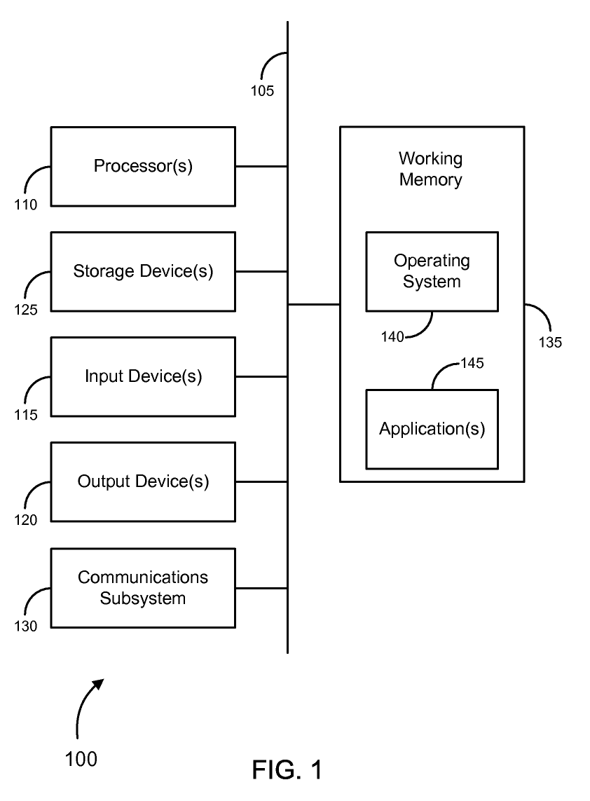

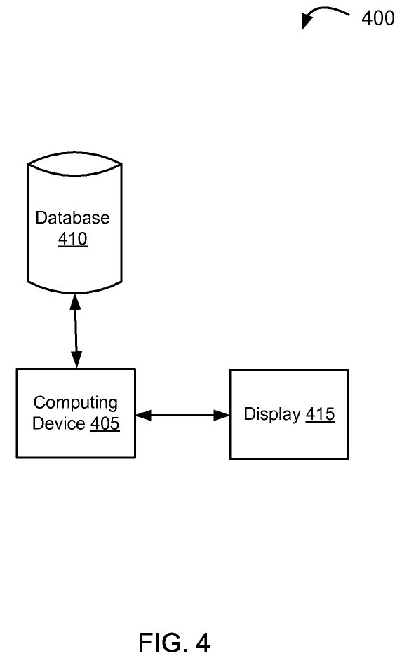

FIG. 1 provides a schematic illustration of one embodiment of a computer system 100 that can perform the methods of the invention, as described herein, and/or can function, for example, as any part of computing system 405 (FIG. 4). It should be noted that FIG. 1 is meant only to provide a generalized illustration of various components, any or all of which may be utilized as appropriate. FIG. 1, therefore, broadly illustrates how individual system elements may be implemented in a relatively separated or relatively more integrated manner.

The computer system 100 is shown comprising hardware elements that can be electrically coupled via a bus 105 (or may otherwise be in communication, as appropriate). The hardware elements can include one or more processors 110, including without limitation one or more general-purpose processors and/or one or more special-purpose processors (such as digital signal processing chips, graphics acceleration chips, and/or the like); one or more input devices 115, which can include without limitation a mouse, a keyboard and/or the like; and one or more output devices 120, which can include without limitation a display device, a printer and/or the like.

The computer system 100 may further include (and/or be in communication with) one or more storage devices 125, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 100 might also include a communications subsystem 130, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 130 may permit data to be exchanged with a network (such as the network described below, to name one example), and/or any other devices described herein. In many embodiments, the computer system 100 will further comprise a working memory 135, which can include a RAM or ROM device, as described above.

The computer system 100 also can comprise software elements, shown as being currently located within the working memory 135, including an operating system 140 and/or other code, such as one or more application programs 145, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer readable storage medium, such as the storage device(s) 125 described above. In some cases, the storage medium might be incorporated within a computer system, such as the system 100. In other embodiments, the storage medium might be separate from a computer system (i.e., a removable medium, such as a compact disc, etc.), and or provided in an installation package, such that the storage medium can be used to program a general purpose computer with the instructions/code stored thereon. These instructions might take the form of executable code, which is executable by the computer system 100 and/or might take the form of source and/or installable code, which, upon compilation and/or installation on the computer system 100 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 100) to perform methods of the invention. According to a set of embodiments, some or all of the procedures of such methods are performed by the computer system 100 in response to processor 110 executing one or more sequences of one or more instructions (which might be incorporated into the operating system 140 and/or other code, such as an application program 145) contained in the working memory 135. Such instructions may be read into the working memory 135 from another machine-readable medium, such as one or more of the storage device(s) 125. Merely by way of example, execution of the sequences of instructions contained in the working memory 135 might cause the processor(s) 110 to perform one or more procedures of the methods described herein.

The terms “machine-readable medium” and “computer readable medium”, as used herein, refer to any medium that participates in providing data that causes a machine to operate in a specific fashion. In an embodiment implemented using the computer system 100, various machine-readable media might be involved in providing instructions/code to processor(s) 110 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 125. Volatile media includes, without limitation dynamic memory, such as the working memory 135. Transmission media includes coaxial cables, copper wire and fiber optics, including the wires that comprise the bus 105, as well as the various components of the communication subsystem 130 (and/or the media by which the communications subsystem 130 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 100. These signals, which might be in the form of electromagnetic signals, acoustic signals, optical signals and/or the like, are all examples of carrier waves on which instructions can be encoded, in accordance with various embodiments of the invention.

The communications subsystem 130 (and/or components thereof) generally will receive the signals, and the bus 105 then might carry the signals (and/or the data, instructions, etc., carried by the signals) to the working memory 135, from which the processor(s) 105 retrieves and executes the instructions. The instructions received by the working memory 135 may optionally be stored on a storage device 125 either before or after execution by the processor(s) 110.

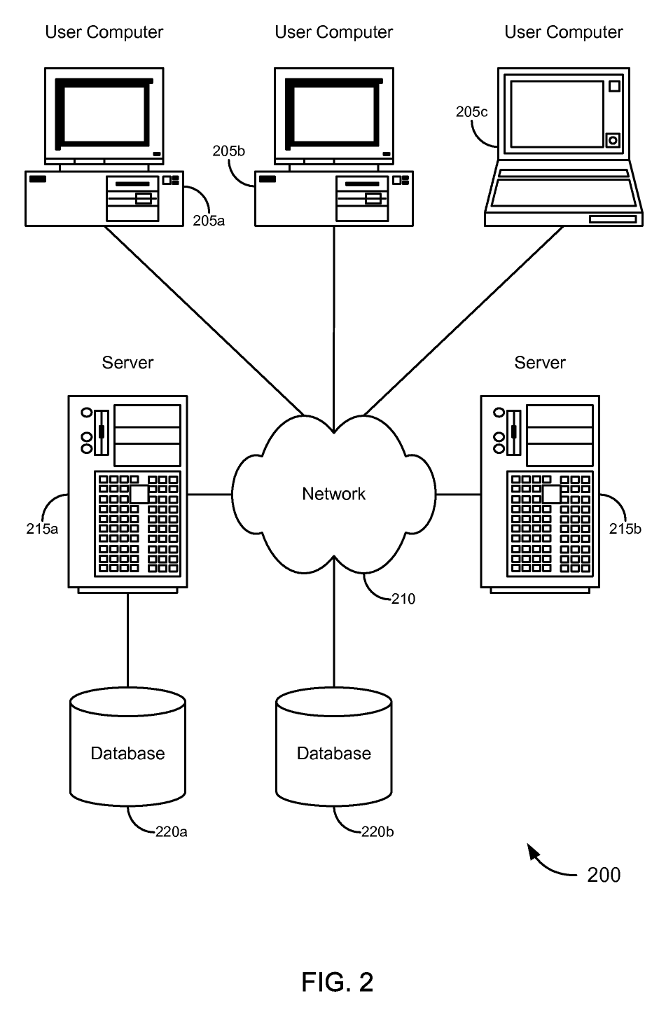

A set of embodiments comprises systems for implementing staged configurator modeling. In one embodiment, user computers 205 and/or servers 215 may be implemented as computer system 100 in FIG. 1. Merely by way of example, FIG. 2 illustrates a schematic diagram of a system 200 that can be used in accordance with one set of embodiments. The system 200 can include one or more user computers 205. The user computers 205 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 205 can also have any of a variety of applications, including one or more applications configured to perform methods of the invention, as well as one or more office applications, database client and/or server applications, and web browser applications. Alternatively, the user computers 205 can be any other electronic device, such as a thin-client computer, Internet-enabled mobile telephone, and/or personal digital assistant (PDA), capable of communicating via a network (e.g., the network 210 described below) and/or displaying and navigating web pages or other types of electronic documents. Although the exemplary system 200 is shown with three user computers 205, any number of user computers can be supported.

Certain embodiments of the invention operate in a networked environment, which can include a network 210. The network 210 can be any type of network familiar to those skilled in the art that can support data communications using any of a variety of commercially-available protocols, including without limitation TCP/IP, SNA, IPX, AppleTalk, and the like. Merely by way of example, the network 210 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 215. Each of the server computers 215 may be configured with an operating system, including without limitation any of those discussed above, as well as any commercially (or freely) available server operating systems. Each of the servers 215 may also be running one or more applications, which can be configured to provide services to one or more clients 205 and/or other servers 215.

Merely by way of example, one of the servers 215 may be a web server, which can be used, merely by way of example, to process requests for web pages or other electronic documents from user computers 205. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 205 to perform methods of the invention.

The server computers 215, in some embodiments, might include one or more application servers, which can include one or more applications accessible by a client running on one or more of the client computers 205 and/or other servers 215. Merely by way of example, the server(s) 215 can be one or more general purpose computers capable of executing programs or scripts in response to the user computers 205 and/or other servers 215, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configurator, database clients, API clients, web browsers, etc.) running on a user computer 205 and/or another server 215. In some embodiments, an application server can create web pages dynamically for displaying the information in accordance with embodiments of the invention, such as web pages displayed by display 415 (FIG. 4). Data provided by an application server may be formatted as web pages (comprising HTML, Javascript, etc., for example) and/or may be forwarded to a user computer 205 via a web server (as described above, for example). Similarly, a web server might receive web page requests and/or input data from a user computer 205 and/or forward the web page requests and/or input data to an application server. In some cases a web server may be integrated with an application server.

In accordance with further embodiments, one or more servers 215 can function as a file server and/or can include one or more of the files (e.g., application code, data files, etc.) necessary to implement methods of the invention incorporated by an application running on a user computer 205 and/or another server 215. Alternatively, as those skilled in the art will appreciate, a file server can include all necessary files, allowing such an application to be invoked remotely by a user computer 205 and/or server 215. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 220. The location of the database(s) 220 is discretionary: merely by way of example, a database 220a might reside on a storage medium local to (and/or resident in) a server 215a (and/or a user computer 205). Alternatively, a database 220b can be remote from any or all of the computers 205, 215, so long as the database can be in communication (e.g., via the network 210) with one or more of these. In a particular set of embodiments, a database 220 can reside in a storage-area network (“SAN”) familiar to those skilled in the art. (Likewise, any necessary files for performing the functions attributed to the computers 205, 215 can be stored locally on the respective computer and/or remotely, as appropriate.) In one set of embodiments, the database 220 can be a relational database, such as an Oracle™ database, that is adapted to store, update, and retrieve data in response to SQL-formatted commands. The database might be controlled and/or maintained by a database server, as described above, for example.

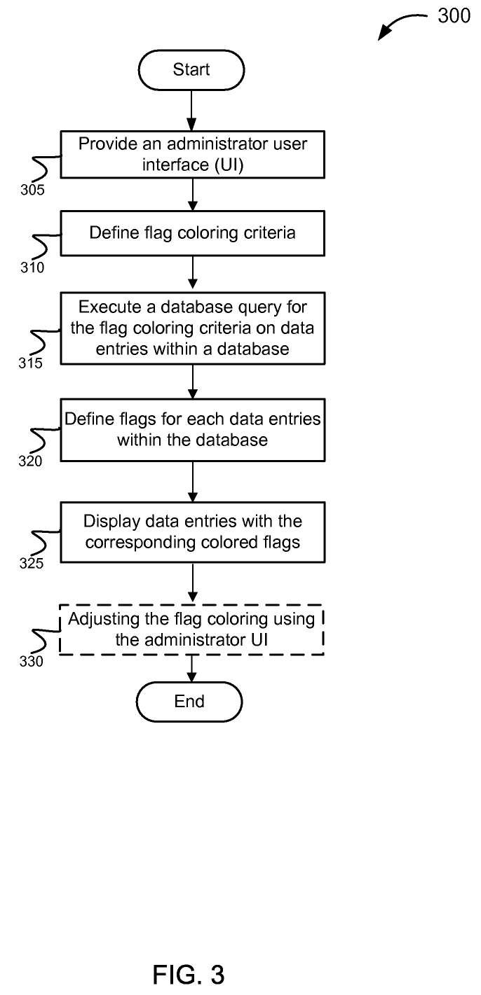

Turning now to FIG. 3, which illustrates a method 300 for differentiating visual information in a user interface (UI). At process block 305, an administrator, a manager, etc. may be provided with an administrator UI. The administrator UI may provide the administrator with various options which may be selected and/or set when, for example, defining a flag coloring criteria. The administrator UI may be dynamically based on the type of data being manipulated, the fields within the data, and so forth. For example, a manager of a group of employees may desire to determine which employees should be given bonuses, raises, deductions, stock option grants, etc. The manager may have access to a database which includes relevant information about the employees and the employees' performance. Such information may include the tenure of the employees, the current salary, goals, performance metrics (e.g., sales figures, R&D data, evaluation information, etc.), raise eligibility, bonus eligibility, stock option eligibility, etc.

The manager may have certain criteria which, based on the data within the database about each employee, would be the basis for the manager's determinations. For example, the manager may determine that sales figures above a certain percentage, tenure over a certain number of years, and an average evaluation score over a certain value will afford the employee both a bonus and a raise. Furthermore, the manager may determine that performance data for an employee below a certain threshold may prohibit the employee from receiving a raise or a bonus. One skilled in the art will appreciate that many permutations of data within the employment database may be used by the manager to make determinations related to raises, bonuses, stock option grant, etc. Furthermore, instead of an employment database, a parts database (or other such database) may be used such that, for example, determinations of which parts to order, discontinue, cut-back, etc. may be made by a parts manager or the like.

Hence, in order to allow the manager to easily see which employees get bonuses, raises, stock option grant, etc., without looking at the raw data within the database, or without self-analyzing data on a display device within a user interface (UI), or without being required to remember their criteria each time a determination is made, the manager may define flag coloring criteria (process block 310). Flag coloring criteria may include assigning a graphical flag color with a certain criteria based on threshold values for data within the database. For example, the manager may determine that employees which meet or exceed a certain threshold will be given both a bonus and a raise and such employees will be denoted by a green graphical flag, whereas employees which fall below the threshold but above another threshold receive only a bonus and are denoted with a yellow flag, and employees which fall below both thresholds do not receive either a bonus or a raise and are denoted by a red flag.

It should be noted that any color may be used and many criteria and thresholds may be defined. For example, a threshold may be based on a percentage of a value within the database, may be based on a Boolean value, and so forth. The manager is given flexibility in defining criteria and/or threshold values. Furthermore, each criteria may have an associated database query used to execute the criteria on the data within the database. In one embodiment, the query may be an SQL query; however, other query types may be used.

Accordingly, at process block 315, the query associated with each of the color flagging criteria may be executed on the data within the database. The query may be configured to analyze the data within the database and determine which entries in the database (i.e., which employees in this particular example) will be assigned which flag color(s). Hence, once each query for each criterion (i.e., each flag color) is executed, the flags for each data entry are defined (process block 320).

At process block 325, based on the defined colored flags, the data entries can then be displayed on a display device within a UI with the corresponding colored flags being displayed with each data entry. Accordingly, the manager may then be able to quickly look at each employee within the database on a display device within a UI and see the color of the flag associated with the employee and make determinations without having to view the raw data or remember the thresholds for each criteria. The manager simply needs to remember that, for example, green flagged employees get a raise and a bonus, yellow flagged employees get only a bonus but not a raise, and red flagged employees do not get either a raise or a bonus. The visualization of the previously defined criteria saves the manager a great deal of time and effort when attempting to make such determinations.

Occasionally, after viewing the color coded flagged data entries, the manager may determine that the criteria and/or thresholds were incorrectly defined, or unexpected and/or unwanted coloring has occurred. As such, at process block 330, the manager may be given the opportunity to redefine the criterion and/or thresholds within the criterion to properly and correctly display the colored flags. The manager may then access the administrator UI and redefine the criteria for one or more of the flag colors. The associated queries may then be re-run, and the data entries displayed with the altered flags. The manager may continue to readjust the criteria until the colored flags are properly displayed.

Furthermore, criteria can also be defined using two fields and a relational operator (e.g., “starts with”, “equals”, “is less than”, “is greater than”, “is less than or equal to”, “is greater than or equal to”, “is not equal to”, “is blank”, etc.) too. The administrator/manager can be allowed to choose fields and an operator to form criteria if pre-defined criteria does not serve the administrator/manager's purpose. In a further embodiment, criteria may also be defined using free form entries which will assist advanced users. For example, the criteria may be [Constant (a) Operator (b) Column (c)] or maybe abc or bac or cab. Such that “a” can be any Constant (e.g., 5, 100 any other variable), “b” can be any Operator (e.g., >, <, >=, <=, =, !=, +, −, *, %), and “c” can be any type (e.g., numeric, alphanumeric, text, date, etc.) of an existing column (e.g., Salary, Bonus, Employee Name, Date of Joining the company, etc.) in any sequence. Also, multiple criteria may be combined using AND, OR, NOR, XOR operators, like ((A>=B) AND (A>=C)).

In addition, one row (which may represent an employee) can have more than one “flag” depending on the criteria defined by a manager/administrator using the administrator UI. Also, if a manager wants to flag a particulate employee, for any reason, he will be able to choose employee and flag them, with any color. This may also be a manual operation. Furthermore, it should be noted that flag is used as a generic term. The flag may be a checkmark, a circle, a dot, a box, or the like. Ultimately, the flag may be any colored representation which allows an administrator or a manager to visually differentiate data entries within a UI display. The flag can be of same size or may vary in shape and size.

Referring now to FIG. 4, which illustrates a system 400 for differentiating visual information in a UI. System 400 may be used to implement method 300 from FIG. 3 described above. In one embodiment, system 400 may include a computing device 405, a database 410, and a display 415. Computing device 405 may be, for example, a server, a client, a middle-tier server, a personal computer, a mobile computer, etc. Furthermore, computing device 405 may be configured to receive definitions for criteria and/or threshold values. For example, computing device 405 may be in connection with display 415, and display 415 may display the administrator UI described above. Accordingly, an administrator or manager may use computing device 405 to input criteria information as well as thresholds.

Furthermore, computing device 405 may be connected with database 410. Computing device 405 may then execute queries associated with the defined criteria on data entries stored within database 410. Database 410 may generate results for the executed queries and transmit the results to computing device 405. Furthermore, computing device 405 may then forward the results to display 415, and display 415 may then display the results with the corresponding graphical flags for viewing by the administrator and/or manager.

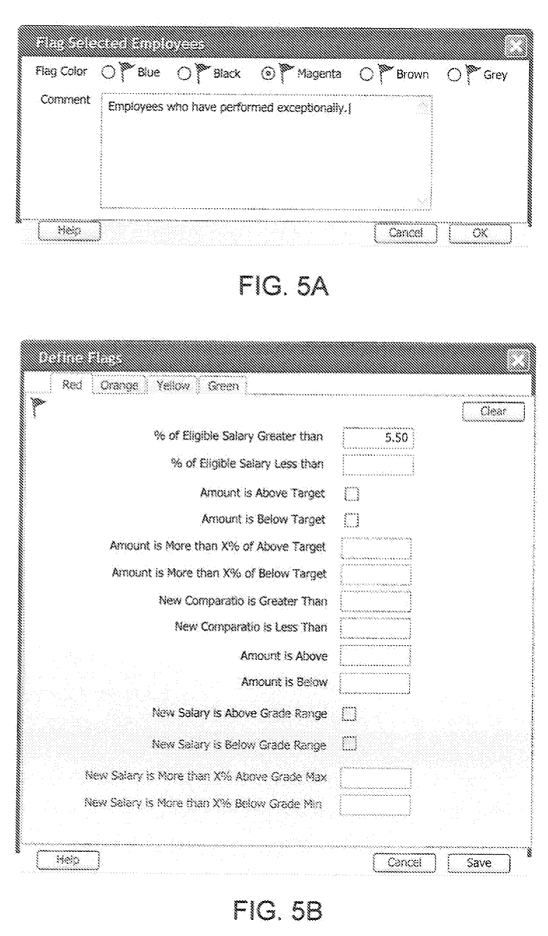

Turning now to FIG. 5A, which illustrates a display of an embodiment of the administrator UI described above. As can be seen in FIG. 5A, the UI displays various colors and allows the administrator or manager to select a colored flag, and then describe the flag color. For example, magenta flags may define exceptional employees. Accordingly, the manager can look back at these definitions when reviewing the data entries in order to allow the manager to know what each flag color means.

FIG. 5B illustrates a further embodiment of the administrator UI according to a further embodiment of the present invention. FIG. 5B provides the administrator or manager with various thresholds for defining the criteria for each flag color. For example, as can be seen in FIG. 5B, the criteria for a red flag may be defined by a percentage of eligible salary greater than a defined value. The criteria may further be defined by an amount above a target, a salary range value, etc. In a further embodiment, the threshold options provided are generated based on the field values included within the database. The threshold options would dynamically change for each database and/or database type. For example, if the database was a parts database instead of an employment database, then the threshold options may be changed to include, the number of items in stock, percentage of items of a certain type sold, etc. Hence, the threshold options for defining the flag criteria as dynamically altered based on the field values and type of database.

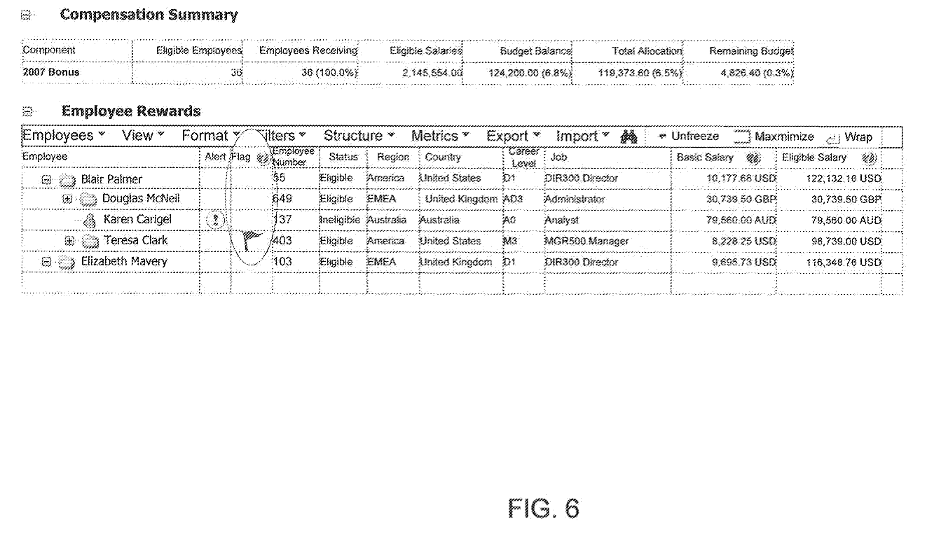

Turning now to FIG. 6, which illustrates a display of results in a UI according to one embodiment of the present invention. As can be seen in FIG. 6, once the query defined by the criterion has been executed and the results are displayed within the UI, the flags are displayed within the data entry. In this example, Karen Carigel has been marked with a red circle with an explication point (i.e., an alert) whereas Teresa Clark has been marked with an orange flag. Hence, based on the definition of the criteria associated with the colored flags displayed, the manager will be able to determine the meaning of the flagging given to Karen Carigel as well as Teresa Clark, in accordance with aspects of the present invention.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware, and/or software configurator. Similarly, while various functionalities are ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A computer implemented method of differentiating visual information in a user interface (UI), the method comprising:
defining criteria for a plurality of flag colors, wherein the criteria is based at least in part on a database query;
executing the database query on a plurality of data entries stored within a database in order to assign at least one of the plurality of flag colors to each of the plurality of data entries, wherein the color of the flag is based at least in part on data included within each of the plurality of data entries meeting the criteria for the color of the flag; and
displaying, within a UI on a display device, the plurality of data entries with the assigned colored flags.

2. The method of claim 1, further comprising providing an administrator UI used to define the criteria.

3. The method of claim 2, wherein the administrator UI is implemented using Java and/or XML.

4. The method of claim 2, wherein the plurality of data entries comprise at least one field.

5. The method of claim 4, wherein the criteria includes the following criteria thresholds: one field is greater than a first value/field, the at least one field is equal to a second value/field, the at least one field is less than a third value/field, and the at least one field is equal to or less than or greater than a percentage of a fourth value/field.

6. The method of claim 5, further comprising assigning, using the administrator UI, a flag color to each criteria threshold.

7. The method of claim 6, further comprising adjusting a criteria threshold using the administrator UI.

8. The method of claim 1, wherein the database is one or more of the following: an employment database, a parts database, and an enterprise database.

9. The method of claim 8, wherein the employment database includes entries and one or more of the following fields: eligible salary, current salary, productivity goal, and productivity goal met.

10. The method of claim 9, further comprising assigning flag colors for the employment database based at least in part on values included within one or more of the employment database's fields.

11. The method of claim 10, wherein the flag color assignments include one or more of the following: a red flag indicates no bonus or raise, a yellow flag indicates only a bonus, and a green flag indicates a bonus and a raise.

12. The method of claim 11, further comprising displaying, for each entry, a colored flag(s) which correspond to flag assignments.

13. The method of claim 12, further comprising analyzing the display of the colored flag(s) to make determinations about the data in the employment database.

14. The method of claim 13, wherein the determinations include granting bonuses and/or raises and/or stock option grants.

15. The method of claim 1, wherein the database query is an SQL query.

16. The method of claim 1, wherein the flags comprise an image(s) which represent a criteria.

17. A system for differentiating visual information in a user interface (UI), the system comprising:
a database configured to store data in data entries and to provide access to the data;
a computing device, coupled with the database, the computing device configured to receive flag color criteria, wherein the criteria is associated with a database query, to execute the database query on the data within the data entries in the database, and to assign graphical colored flags to each of the data entries based on the criteria; and
a display, coupled with the computing device, the display configured to display each of the data entries with each of the data entry's assigned colored flag.

18. The system of claim 17, wherein the computing system comprises one or more of the following: a server, a client, a middle-tier system, personal computer, and a portable computer.

19. The system of claim 17, wherein the display is further configured to display an administration UI, wherein the administration UI is used to assign the criteria.

20. A machine-readable medium for differentiating visual information in a user interface (UI), the machine-readable medium including sets of instructions which, when executed by a machine, cause the machine to:
define criteria for a plurality of flag colors, wherein the criteria is based at least in part on a database query;
execute the database query on a plurality of data entries stored within a database in order to assign at least one of the plurality of flag colors to each of the plurality of data entries, wherein the color of the flag is based at least in part on data included within each of the plurality of data entries meeting the criteria for the color of the flag; and
display, within a UI on a display device, the plurality of data entries with the assigned colored flags.
